(19) United States
(12) Patent Application Publication
(10) Pub. No.: US 2011/0058684 A1
(43) Pub. Date: Mar. 10, 2011

(54) AUDIO REPRODUCTION DEVICE

(75) Inventors: Yoshiki Ohta, Kanagawa (JP); Kensaku Obata, Kawasaki (JP)

(73) Assignee: PIONEER CORPORATION, Kawasaki-shi, Kanagawa (JP)

(21) Appl. No.: 12/991,478

(22) PCT Filed: May 27, 2008
(86) PCT No.: PCT/JP2008/059736

§ 371 Date: Nov. 8, 2010

(51) Int. Cl. H04R 1/40

(52) U.S. Cl. 381/97

(57) ABSTRACT

An audio reproduction device reproduces a one-channel signal from two speakers arranged in a sound field. The one-channel input signal is delayed by a delay element. The delay element performs a delay with different delay amount for a plurality of frequency bands. The signal delayed by the delay element is outputted to one of the two speakers and the input signal is directly outputted to the other one of the two speakers.

### TECHNICAL FIELD

The present invention relates to an audio reproduction device which reproduces audio by a plurality of speakers.

### BACKGROUND TECHNIQUE

In an on-vehicle audio reproduction device, a left speaker and a right speaker are mounted on the positions asymmetric with each other with respect to a listener. For example, at the driver's seat, the sound from the right speaker (stereo right signal) is large and the sound from the left speaker (stereo left signal) is small. In order to obtain good stereophonic feeling, it is necessary to equalize the balance of the sound pressure levels from the left and the right speakers. When the sound from the left speaker is made larger, by the amplifier, so as to equalize the balance of the left and right sound pressure levels at the driver's seat, the sound from the left speaker becomes still larger at the assistant driver's seat. Therefore, there is a demand of a technique of adjusting the balance of the sound pressure levels from the left and right speakers at both the driver's seat and the assistant driver's seat.

From this point of view, the Patent Reference-1 realizes approximately equal sound pressure levels at the driver's seat and the assistant driver's seat at each frequency band by utilizing the directivity of the speakers. However, the method of the Patent Reference-1 has the following problems.

The first problem is that the desired characteristic can be obtained only at the low frequency band equal to or larger than 3 kHz. The second problem is that the method cannot flexibly correspond to the change of the vehicle type and the speaker layout, because the method depends on the characteristics of the speakers.

### Patent Reference-1:

Japanese Patent Application Laid-open under No. H05-161192

### DISCLOSURE OF INVENTION

### Problem to be Solved by the Invention

The above is one example of the problem to be solved by the present invention. It is an object of the present invention to provide an audio reproduction device which can reproduce sound with equal sound pressure levels at both the left and the right seats, which is effective even at a high frequency band and which can flexibly correspond to the change of the speaker layout.

### Means for Solving the Problem

The invention of claim 1 is an audio reproduction device connected to two speakers arranged in a sound field, comprising: an input means which receives an input signal of one channel; a delay means which delays the input signal; and an output means which outputs the input signal delayed by the delay means to one of the two speaker and outputs the input signal received by the input means to the other one of the two speakers, wherein the delay means gives, to the input signal, a delay of different delay amount to each of a plurality of frequency bands.

The invention of claim 7 is an audio reproduction device connected to two pairs of speakers arranged in a sound field, comprising: an input means which receives the input signals of two channels; a delay means which delays the input signals of two channels, respectively; and an output means which outputs the input signal delayed by the delay means to one of the two speaker and outputs the input signal received by the input means to the other one of the two speakers, for the respective pairs of speakers, wherein the delay means gives, to the input signal, a delay of different delay amount to each of a plurality of frequency bands that the input signal has.

### BRIEF DESCRIPTION OF THE DRAWINGS

FIG. 1 schematically shows a speaker layout according to an embodiment.

FIGS. 2A and 2B are block diagrams showing a configuration of an audio reproduction device.

FIGS. 3A and 3B show distributions of sound pressure level at the driver's seat and the assistant driver's seat.

FIG. 4 shows a difference of the sound pressure levels at the driver's seat and the assistant driver's seat.

FIGS. 5A and 5B show an optimum delay amount for each frequency band in a first embodiment.

FIG. 6 shows a difference of the sound pressure levels at the driver's seat and the assistant driver's seat for each frequency band.

FIG. 7 shows a delay amount segment in a second embodiment.

FIGS. 8A and 8B show an optimum delay amount of a right channel signal in the second embodiment.

FIGS. 9A and 9B show an optimum delay amount of a left channel signal in the second embodiment.

### DESCRIPTION OF REFERENCE NUMBERS

5L, 5R Input signal
6L, 6R Mixer
7L, 7R 1ch processing unit
8R Frequency band dividing unit
9R Delay unit

### MOST PREFERRED FORM TO EXERCISE THE INVENTION

According to one aspect of the present invention, there is provided an audio reproduction device connected to two speakers arranged in a sound field, comprising: an input means which receives an input signal of one channel; a delay means which delays the input signal; and an output means which outputs the input signal delayed by the delay means to one of the two speaker and outputs the input signal received by the input means to the other one of the two speakers, wherein the delay means gives, to the input signal, a delay of different delay amount to each of a plurality of frequency bands.

The above audio reproduction device reproduces the signal of one channel from two speakers in a sound field. The input signal of one channel is delayed by the delay means. The delay means delays the input signal by the different delay amount for each of the plurality of frequency band. The signal delayed by the delay means is outputted to one of the two speakers, and the input signal is outputted to the other of the two speakers as it is.

In one mode of the above audio reproduction device, the delay means delays the input signal such that a difference between a sound pressure at one listening position in the sound field and a sound pressure at another listening position becomes zero, for audio outputted from the two speakers.

In another mode of the above audio reproduction device, the delay means delays the input signal such that a difference between a sound pressure at one listening position in the sound field and a sound pressure at another listening position becomes maximum, for audio outputted from the two speakers.

In a preferred example, the delay means sets the delay amount larger for the frequency band whose frequency is higher. In another preferred example, the one of the two speakers is a speaker which is near to the listening position in the sound field and the other one of the two speakers is a speaker which is farther from the listening position.

In another preferred example, the delay means comprises: a frequency band dividing section which divides the input signal to the plurality of frequency bands; and a delaying section which gives the delay to the signals of the plurality of frequency bands divided by the frequency dividing section.

According to another aspect of the present invention, there is provided an audio reproduction device connected to two pairs of speakers arranged in a sound field, comprising: an input means which receives the input signals of two channels; a delay means which delays the input signals of two channels, respectively; and an output means which outputs the input signal delayed by the delay means to one of the two speaker and outputs the input signal received by the input means to the other one of the two speakers, for the respective pairs of speakers, wherein the delay means gives, to the input signal, a delay of different delay amount to each of a plurality of frequency bands that the input signal has.

The above audio reproduction device reproduces the two-channel signal by two pairs of speakers. Namely, one-channel signal is reproduced by one pair of speakers, and other one-channel signal is reproduced by the other pair of speakers. For each channel, the one-channel input signal is delayed by the delay means. The delay means delays the input signal by the delay amount different for each of the plurality of frequency bands. For each channel, the signal delayed by the delay means is outputted to the one of the two speakers, and the input signal is outputted to the other of the two speakers as it is.

In one mode of the above audio reproduction device, the delay means delays the input signal such that a difference between a sound pressure at one listening position in the sound field and a sound pressure at another listening position becomes zero, for audio outputted from the two pairs of speakers, respectively.

In another mode of the above audio reproduction device, the delay means delays the input signal such that a difference between a sound pressure at one listening position in the sound field and a sound pressure at another listening position becomes maximum, for audio outputted from the two pairs of speakers, respectively.

### EMBODIMENT

Preferred embodiments of the present invention will be described below with reference to the attached drawings.

### 1st Embodiment

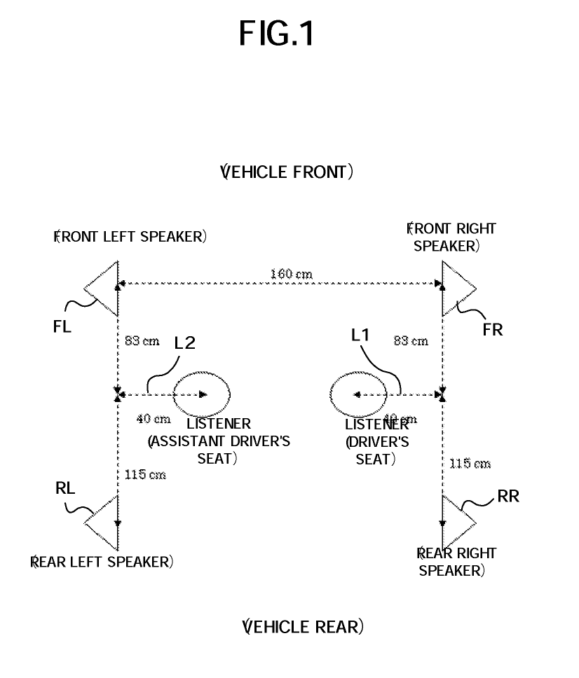

FIG. 1 shows a speaker layout of an audio reproduction device according to a first embodiment. FIG. 1 schematically shows the positions of the speakers and the listener in a vehicle. In the vehicle, a front right (R) speaker FR, a rear right (R) speaker RR, a front left (L) speaker FL and a rear left (L) speaker RL, i.e., four speakers in total, are arranged. The driver's seat is near the right speakers, and the assistant driver's seat is near the left speakers. The positional relationship of the four speakers, the driver's seat and the assistant driver's seat are as indicated by the numerical values in FIG. 1.

As shown, the driver's seat exists on the segment L1 perpendicular to the segment which connects the front right speaker FR and the rear right speaker RR. The assistant driver's seat exists on the segment L2 perpendicular to the segment which connects the front left speaker FL and the rear left speaker RL. In this embodiment, the segment L1 and the segment L2 are on an extension line, and therefore the driver's seat and the assistant driver's seat are on an identical line. Namely, both the driver's seat and the assistant driver's seat are on the segment L1 perpendicular to the segment which connects two right speakers and also on the segment L2 perpendicular to the segment which connects two left speakers. The driver's seat and the assistant driver's seat correspond to the listening position in the present invention.

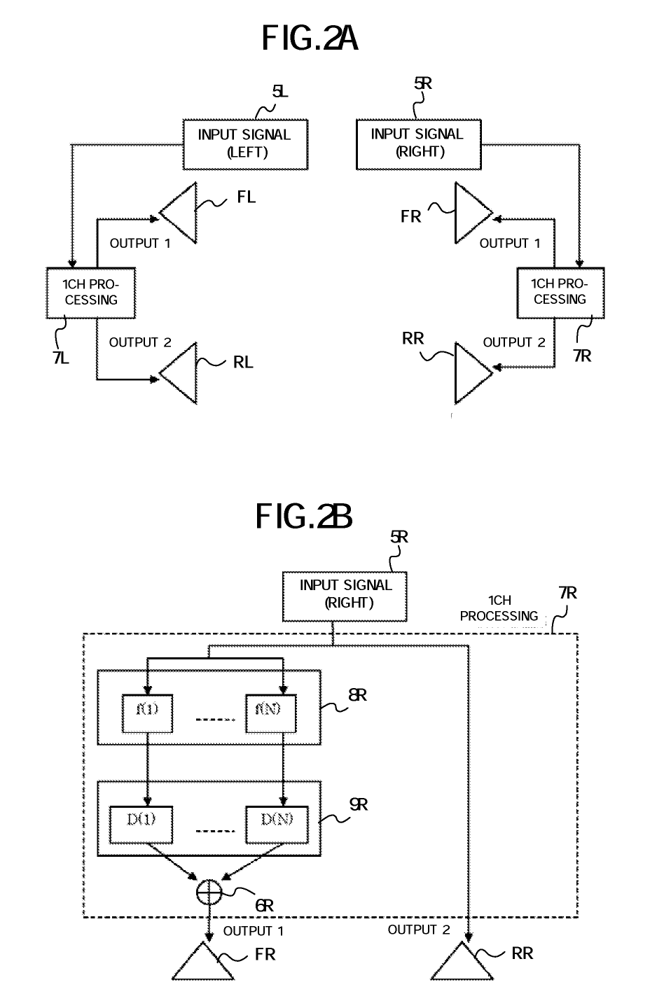

FIG. 2A schematically shows the configuration of the audio reproduction device according to the first embodiment. The input signal 5R for the right speakers is inputted to the 1ch processing unit 7R. The 1ch processing unit 7R applies the delay control processing to the input signal 5R, and supplies it to the front right speaker FR and the rear right speaker RR. Similarly, the input signal 5L for the left speakers is inputted to the 1ch processing unit 7L. The 1ch processing unit 7L applies the delay control processing to the input signal 5L, and supplies it to the front left speaker FL and the rear left speaker RL.

FIG. 2B shows the configuration of the 1ch processing unit 7R for the right speakers. The 1ch processing unit 7R includes a mixer 6R, a frequency band dividing unit 8R and a delay unit 9R. In the 1ch processing unit 7R, first the input signal 5R is directly outputted to the rear right speaker RR without receiving any signal processing. Also, the input signal 5R is supplied to the frequency band dividing unit 8R. The frequency band dividing unit 8R includes a plurality of frequency band dividing filters, and divides the input signal 5R into the signals of a predetermined plural frequency bands. Specifically, the frequency band dividing unit 8R sets each of the frequency band width to ⅓ octave, and sets the center frequencies f(1)-f(N) of the respective frequency bands to 205 Hz-2 kHz.

The signals of the respective frequency bands thus divided are transferred to the delay unit 9R. The delay unit 9R gives the delays of different delay amount to the signals of the respective frequency bands, and then outputs them to the mixer 6R. The mixer 6R synthesizes the signals to which different delays are given for the respective frequency bands by the delay unit 9R, and outputs the signal to the front right speaker FR.

The configuration of the 1ch processing unit 7L for the left speakers is basically the same as the 1ch processing unit 7R for the right speakers. Namely, the 1ch processing unit 7L divides the input signal 5L into a predetermined plural frequency bands, and gives the different delays for the respective frequency bands to output to the front left speaker FL. At the same time, the 1ch processing unit 7L outputs the input signal 5L to the rear left speaker RL as it is.

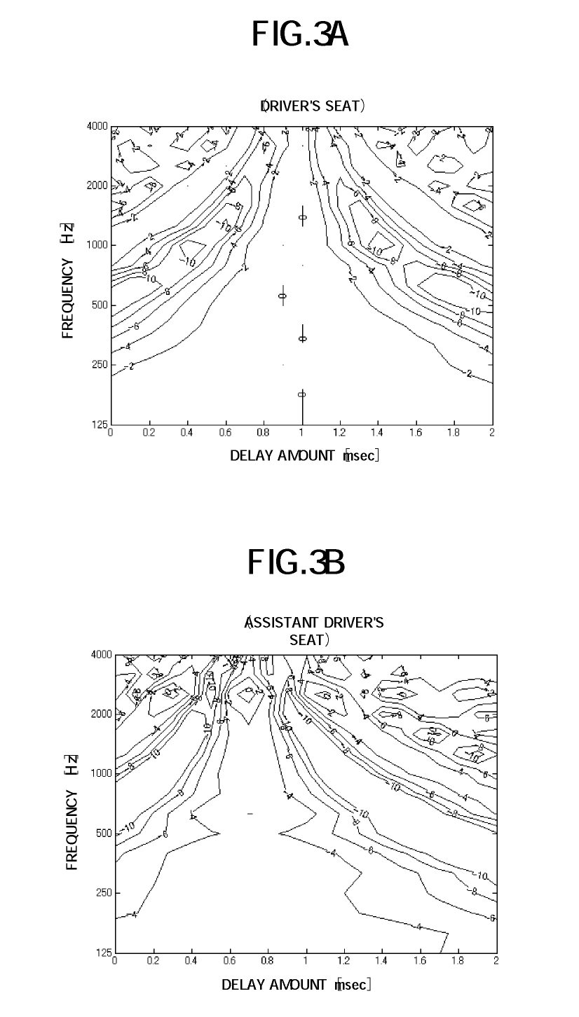

FIG. 3A shows a sound pressure distribution at the driver's seat when the above-mentioned 1ch processing unit 7R is operated to vary the delay amounts for the respective frequency bands. FIG. 3A shows the sound pressure value (dB) by the contour lines. The vertical axis indicates the frequency, and the horizontal axis indicates the delay amount. As shown, when the delay amount is approximately 1 msec, the sound pressure becomes large for the entire frequency band (0 to −2 dB). Namely, it is understood that, when the delay amount is approximately 1 msec, the difference between the distance to the front right speaker FR and the distance to the rear right speaker RR is just corrected by the delay, and the sounds outputted from two speakers emphasize with each other most strongly.

Meanwhile, FIG. 3B shows a sound pressure distribution at the assistant driver's seat when the above-mentioned 1ch processing unit 7R is operated to vary the delay amounts of the respective frequency bands. FIG. 3B shows the sound pressure value (dB) by the contour lines, too. As shown, when the delay amount is approximately 0.7 msec, the sound pressure becomes large for the entire frequency band (−2 to −4 dB). Since the difference between the distance to the front right speaker FR and the distance to the rear right speaker RR is small at the assistant driver's seat, compared with the driver's seat, the high sound pressure is obtained with the delay amount smaller than that at the driver's seat.

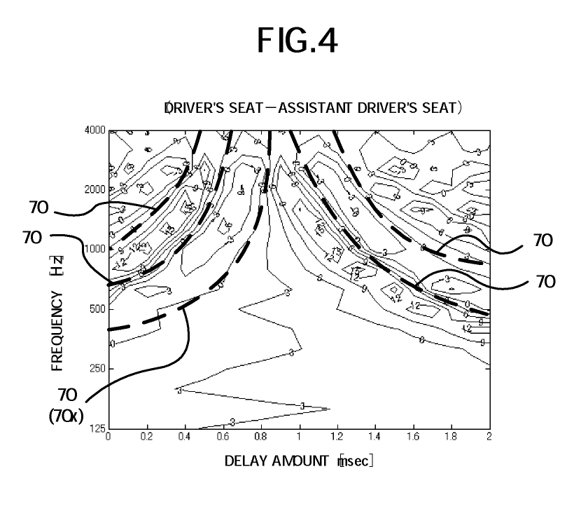

Next, FIG. 4 shows the result of subtracting the sound pressure distribution of FIG. 3B from the sound pressure distribution of FIG. 3A. Namely, FIG. 4 is the sound pressure distribution of (Driver's Seat-Assistant Driver's Seat). In FIG. 4, plural broken lines 70 show the segments formed by the points at which the sound pressure value becomes approximately zero, i.e., at which the sound pressure at the driver's seat is approximately equal to the sound pressure at the assistant driver's seat. As shown, there periodically exist plural segments, on which the sound pressure at the driver's seat is approximately equal to the sound pressure at the assistant driver's seat. Out of them, the segment 70x is determined as the segment for determining the delay amount (hereinafter referred to as “delay amount segment”), in consideration of such conditions that (1) the sound pressure becomes largest and that (2) it covers broad frequency band. The delay amount segment 70x gives the delay amount for each frequency band in case that the sound pressure at the driver's seat is approximately equal to the sound pressure at the assistant driver's seat (i.e., the sound pressure difference becomes zero).

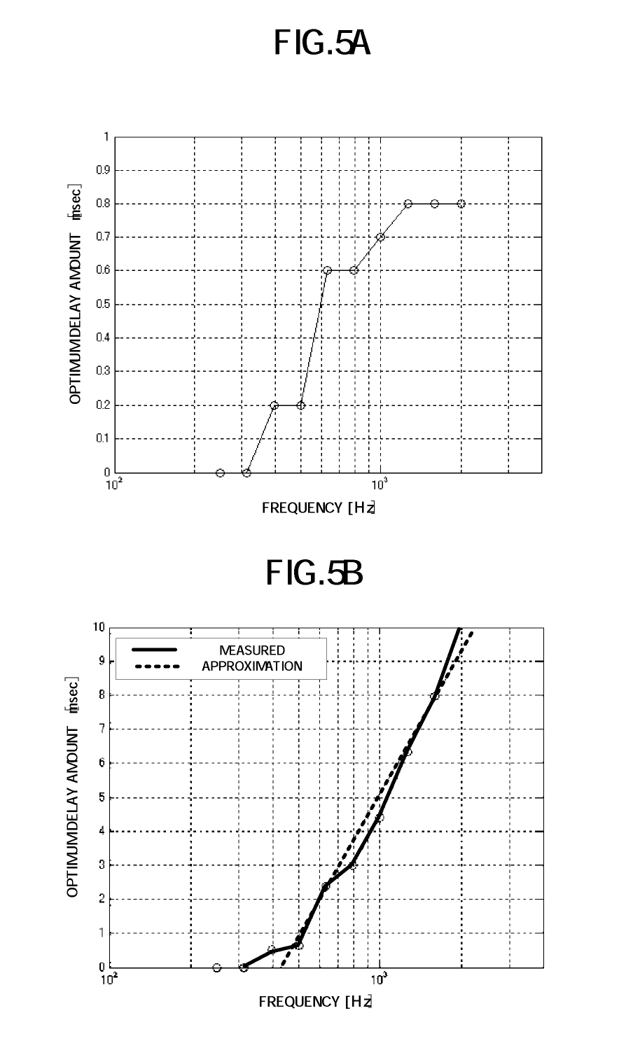

FIG. 5A shows the optimum delay amount for each frequency band, determined based on the delay amount segment 70x. In FIG. 5A, the horizontal axis indicates the frequency, and the vertical axis indicates the optimum delay amount. Further, FIG. 5B shows the graph obtained by converting the optimum delay amount shown in FIG. 5A to the phase (radian) and plotting the phase values against the logarithmic frequency. It is understood that the optimum delay amount increases approximately linearly against the logarithmic frequency. FIG. 5B also shows the graph obtained by the linear approximation of the segments of the optimum delay amount. The line obtained by the linear approximation is:

p(f)=a*log₁₀(f)+b (1)

wherein: a=13.8, b=−36.5, p:phase [radian], f:frequency[Hz].

As described above, by determining the delay amount of each frequency band by the delay unit 9R in the 1ch processing unit 7R in accordance with the characteristic between the frequency and the delay amount shown in FIG. 5B, the sounds outputted by the front right speaker FR and by the rear right speaker RR are heard with the equal level, both at the driver's seat and the assistant driver's seat.

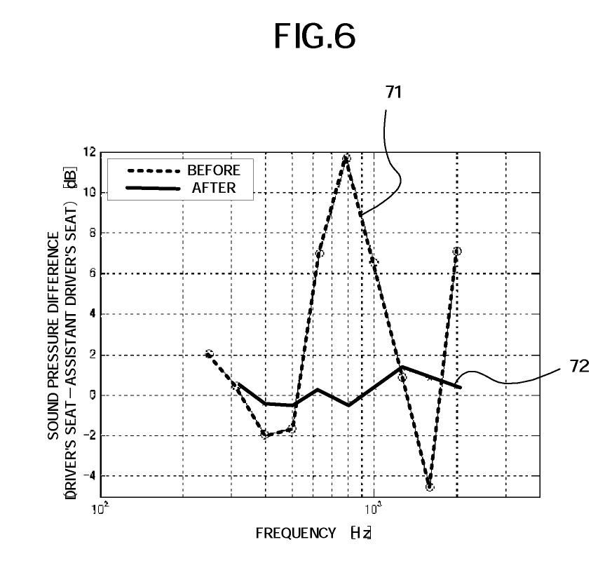

FIG. 6 shows the difference between the sound pressure level at the driver's seat and the sound pressure level at the assistant driver's seat, when the above-described delay control processing is performed and not performed. The horizontal axis indicates the frequency, and the vertical axis indicates the sound pressure difference between the driver's seat and the assistant driver's seat. The graph 71 (before processing) shows the sound pressure difference in the case that the delay control processing is not performed, and the graph 72 (after processing) shows the sound pressure difference in the case that the delay control processing is performed. As shown by the graph 71, in the case that the delay control processing is not performed, the sound pressure difference is large at each frequency band, 12 dB at the largest. In contrast, as shown by the graph 72, in the case that the delay control processing is performed, the sound pressure difference is suppressed to be within 2 dB at any frequency band.

In the above description, the characteristics shown in FIGS. 3 to 6 are obtained by the speaker layout shown in FIG. 1. However, if the speaker layout is changed, the delay control processing can be executed by the same method. If the speaker layout is changed, the distances from the front speaker and the rear speaker to the driver's seat and the assistant driver's seat change. But, in that case, only the delay amount indicated by the horizontal axis changes in the sound pressure distribution of the driver's seat shown in FIG. 3A and the sound pressure distribution of the assistant driver's seat shown in FIG. 3B. Therefore, in the sound pressure distribution of (Driver's Seat—Assistant Driver's Seat) obtained by the arithmetic operation, the delay amount segment becomes the segment extending from the upper center area of the graph to the left and right lower areas of the graph like FIG. 4, and the optimum delay amount characteristic obtained from the delay amount segment has an tendency of extending in the upper right direction, as a whole, like FIG. 5B. Therefore, the method of this embodiment can be generally applied to the vehicle having different speaker layout.

While the above description is directed to the right speakers, the delay control processing can be performed for the left speakers in the same manner, so as to set the delay amount for each frequency band. Namely, for the two left speakers, the sound pressure distribution at the driver's seat and the sound pressure distribution at the assistant driver's seat are measured, the sound pressure distribution of (Driver's Seat-Assistant Driver's Seat) is generated by the subtraction, and the optimum delay amount with which the sound pressure difference becomes zero is obtained on the distribution. Then, the delay amount for each frequency band can be determined based on the optimum delay amount.

Since the method of this embodiment adjusts only the time of the front speaker, the sound from the front speaker further delays, and reaches the rear seat of the vehicle after being attenuated by the amount corresponding to the distance. Therefore, the sound interference occurring at the front seats (the driver's seat and the assistant driver's seat) hardly occur. As a result, the person sitting on the rear seat can enjoy the stereophonic reproduction by the sound from the rear speakers, to which no processing is applied. In addition, since the method of this embodiment does not electrically vary the frequency characteristic like the equalizer, it is possible to enjoy the high quality music at any seat in the vehicle.

### 2nd Embodiment

In the second embodiment, the speaker layout is the same as that shown in FIG. 1, and the configuration of the device is the same as that shown in FIG. 2.

In the above-described first embodiment, the delay amount is controlled such that the sound pressure levels at the driver's seat and the assistant driver's seat becomes equal to each other. In contrast, in the second embodiment, the delay amount is controlled such that the difference of the sound pressure levels at the driver's seat and the assistant driver's seat becomes maximum.

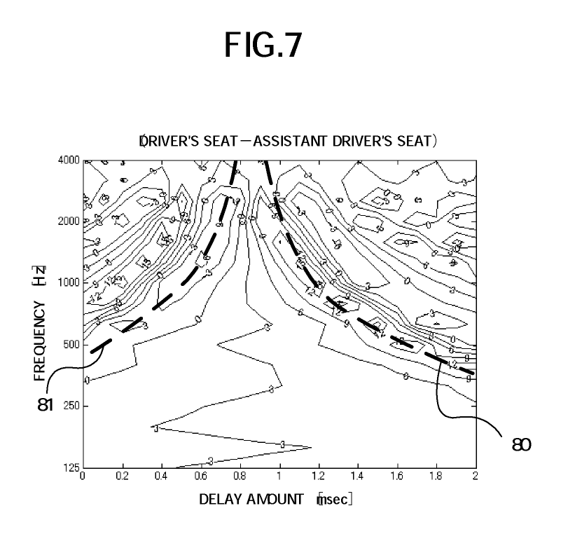

FIG. 7 is the same figure as FIG. 4, and shows the sound pressure difference between the driver's seat and the assistant driver's seat in case that the signals are outputted from the front right speaker FR and the rear right speaker RR in the same configuration as that of the first embodiment. Here, the segment connecting the points at which the sound pressure difference (Driver's Seat-Assistant Driver's Seat) becomes maximum is the delay amount segment 80. Namely, by determining the delay amount of each frequency band based on the delay amount segment 80, the sound pressure difference between the driver's seat and the assistant driver's seat can be maximum for the sounds outputted from two right speakers.

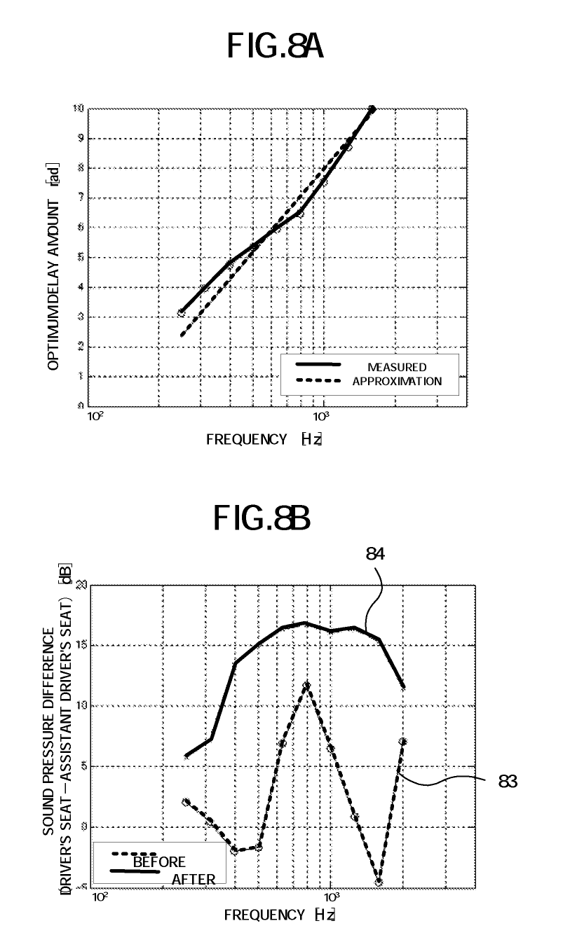

FIG. 8A shows the optimum delay amount (radian) determined based on the delay amount segment 80. In FIG. 8A, the horizontal axis is a logarithmic axis indicating the frequency, and the vertical axis indicates the optimum delay amount. FIG. 8A also shows the linear approximation segment obtained based on the plots of the optimum delay amounts. The linear approximation segment is expressed by the following equation:

p(f)=a*log₁₀(f)+b (2)

wherein a=9.3 and b=−20.0

By determining the delay amount of each frequency band according to FIG. 8A, the sound pressure level of the sound outputted from two right speakers FR and RR becomes maximum at the driver's seat.

FIG. 8B shows the sound pressure level difference between the driver's seat and the assistant driver's seat in the case that the above-described processing is performed and not performed. When the above-described processing is not performed, as shown by the graph 83, the sound pressure level difference between the driver's seat and the assistant driver's seat are largely different depending upon the frequency band. In contrast, when the above-described processing is performed, as shown by the graph 84, the sound pressure level difference between the driver's seat and the assistant driver's seat is larger than the graph 83 as a whole, and is about 15 dB at the maximum.

Returning to FIG. 7, the segment connecting the points at which the sound pressure difference between the driver's seat and the assistant driver's seat (Assistant driver's seat-Driver's seat) becomes maximum is the delay amount segment 81. The delay amount segment 81 is the segment at which the sound pressure difference of (Driver's Seat-Assistant Driver's Seat) becomes the negative maximum. As shown in FIG. 1, since the left and right speakers are arranged symmetrically, the delay amount segment 81 is equivalent to the segment at which the sound pressure level at the assistant driver's seat becomes maximum for the sound outputted from two left speakers FL and RL. Therefore, for the input signal for the left speakers, the optimum delay amount may be determined based on the delay amount segment 81.

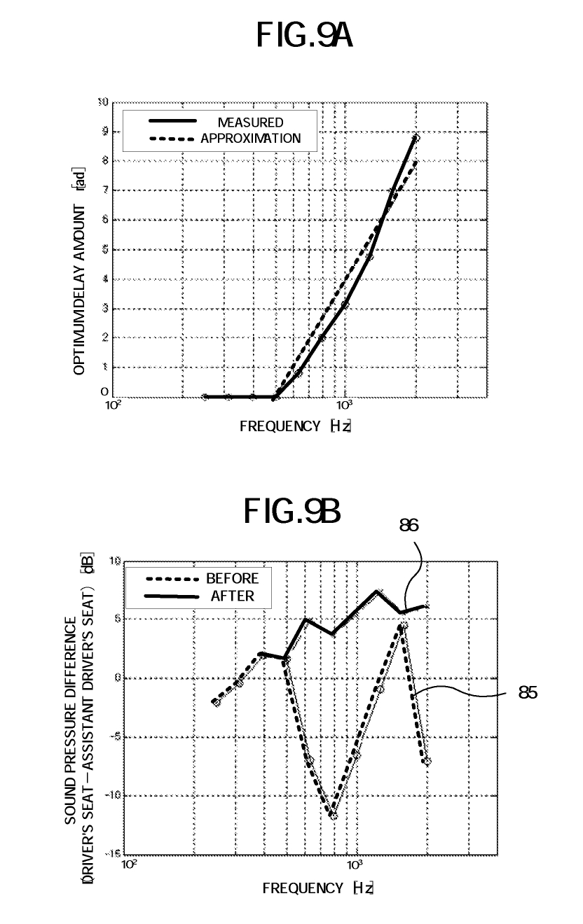

FIG. 9A shows the optimum delay amount (radian) determined based on the delay amount segment 81. In FIG. 9A, the horizontal axis is the logarithmic axis indicating the frequency, and the vertical axis indicates the optimum delay amount. FIG. 9A also shows the linear approximation segment obtained by the plots of the optimum delay amounts. The linear approximation segment is expressed by the following equation.

p(f)=a*log₁₀(f)+b (2)

wherein a=13.0 and b=−35.0.

By determining the delay amount of each frequency band according to FIG. 9A, the sound pressure level of the sound outputted from two left speakers FL and RL becomes maximum at the assistant driver's seat.

FIG. 9B shows the sound pressure level difference between the driver's seat and the assistant driver's seat in the case that the above-described processing is performed and not performed. When the above-described processing is not performed, as shown by the graph 85, the sound pressure level difference between the driver's seat and the assistant driver's seat are largely different depending upon the frequency band. In contrast, when the above-described processing is performed, as shown by the graph 86, the sound pressure level difference between the driver's seat and the assistant driver's seat is larger than the graph 85 as a whole.

As described above, in the second embodiment, by determining the delay amounts such that the sound pressure level difference between the driver's seat and the assistant driver's seat becomes maximum, the sound pressure level difference of the sound outputted from the left and right speakers can be maximum at the driver's seat or the assistant driver's seat. Thus, for example, by making the sound pressure level difference from two right speakers becomes maximum at the driver's seat, it is possible to make the guide voice of the car navigation be audible only at the driver's seat.

### Modified Example

The present invention provides a device which equalizes the sound pressures at two seats arranged on the segment perpendicular to the segment which connects two speakers. Therefore, not only the above-described embodiments, the sound pressures can be equalized at two seats arranged in front and behind, by using two front speakers. This is effective in the case that monophonic signal or a center signal of 5.1ch surround signals is reproduced by two front speakers.

### INDUSTRIAL APPLICABILITY

This invention can be used for a sound field correction of an on-vehicle audio apparatus.

1-9. (canceled)

10. An audio reproduction device connected to two speakers arranged in a sound field, comprising:
an input unit which receives an input signal of one channel;
a delay unit which delays the input signal; and
an output unit which outputs the input signal delayed by the delay unit to one of the two speaker and outputs the input signal received by the input unit to the other one of the two speakers,
wherein the delay unit gives, to the input signal, a delay of different delay amount to each of a plurality of frequency bands, and
wherein the delay unit sets the delay amount larger for the frequency band whose frequency is higher.

11. The audio reproduction device according to claim 10, wherein the delay unit sets a phase shift amount of each frequency band to a value directly proportional to a logarithmic frequency.

12. The audio reproduction device according to claim 10, wherein the delay unit delays the input signal such that a difference between a sound pressure at one listening position in the sound field and a sound pressure at another listening position becomes zero, for audio outputted from the two speakers.

13. The audio reproduction device according to claim 10, wherein the delay unit delays the input signal such that a difference between a sound pressure at one listening position in the sound field and a sound pressure at another listening position becomes maximum, for audio outputted from the two speakers.

14. The audio reproduction device according to claim 10, wherein the one of the two speakers is a speaker which is near to a listening position in the sound field and the other one of the two speakers is a speaker which is farther from the listening position.

15. The audio reproduction device according to claim 10, wherein the delay unit comprises:
a frequency band dividing section which divides the input signal to the plurality of frequency bands; and
a delaying section which gives the delay to the signals of the plurality of frequency bands divided by the frequency dividing section.

16. An audio reproduction device connected to two pairs of speakers arranged in a sound field, comprising:
an input unit which receives the input signals of two channels;
a delay unit which delays the input signals of two channels, respectively; and
an output unit which outputs the input signal delayed by the delay unit to one of the two speaker and outputs the input signal received by the input unit to the other one of the two speakers, for the respective pairs of speakers,
wherein the delay unit gives, to the input signal, a delay of different delay amount to each of a plurality of frequency bands that the input signal has, and
wherein the delay unit sets the delay amount larger for the frequency band whose frequency is higher.

17. The audio reproduction device according to claim 16, wherein the delay unit sets a phase shift amount of each frequency band to a value directly proportional to a logarithmic frequency.

18. The audio reproduction device according to claim 17, wherein the delay unit delays the input signal such that a difference between a sound pressure at one listening position in the sound field and a sound pressure at another listening position becomes zero, for audio outputted from the two pairs of speakers, respectively.

19. The audio reproduction device according to claim 17, wherein the delay unit delays the input signal such that a difference between a sound pressure at one listening position in the sound field and a sound pressure at another listening position becomes maximum, for audio outputted from the two pairs of speakers, respectively.
